(19) United States
(12) Patent Application Publication
(10) Pub. No.: US 2015/0030716 A1
(43) Pub. Date: Jan. 29, 2015

(54) ANIMAL ATTRACTANT AND/OR FEED AND METHOD OF PRODUCING SAME

(71) Applicant: ROBERT D. WALLACE, Alachua, FL (US)

(72) Inventor: ROBERT D. WALLACE, Alachua, FL (US)

(21) Appl. No.: 14/505,099

(22) Filed: Oct. 2, 2014

Related U.S. Application Data
(62) Division of application No. 14/275,736, filed on May 12, 2014.
(60) Provisional application No. 61/824,291, filed on May 16, 2013.
(60) Provisional application No. 61/984,414, filed on Apr. 25, 2014.

(51) Int. Cl. A23K 1/14

(52) U.S. Cl. CPC A23K 1/14
USPC 426/1; 426/2

(57) ABSTRACT

Embodiments pertain to a method of attracting and/or feeding one or more animals, including game, wildlife, deer, whitetail deer (Odocoileus virginianus), moose, elk, antelope, goats, cows, horses, turkey, birds, raccoons, chipmunks, donkeys, elephants, possum, squirrels, rabbits, mice, and buffalo. Embodiments relate to a nutritional food source (feed) and/or attractant that incorporates one or more of the following: whole chestnuts; chestnut kernels and/or kernel pieces; and ground chestnut flour. Embodiments incorporate chestnut flour and one or more of the following: whole chestnuts; chestnut kernels; and kernel pieces. Specific embodiments incorporate one or more of the following: whole chestnuts; chestnut kernels; kernel pieces, and incorporate less than 2%, less than 1%, less than 0.9%, less than 0.8%, less than 0.7%, less than 0.6%, and/or less than 0.5% chestnut flour. The attractant and/or feed can be used to feed and/or attract game, wildlife, deer, whitetail deer (Odocoileus virginianus), and/or other animals.

### CROSS-REFERENCE TO RELATED APPLICATIONS

The present application is a divisional of U.S. application Ser. No. 14/275,736, filed May 12, 2014, which claims the benefit of U.S. Provisional Application Ser. No. 61/824,291, filed May 16, 2013, and U.S. Provisional Application Ser. No. 61/984,414, filed Apr. 25, 2014, all of which are hereby incorporated by reference herein in their entirety, including any figures, tables, or drawings.

### BACKGROUND OF INVENTION

Embodiments of the subject invention relate to a nutritional food source (feed) and/or attractant incorporating chestnuts, and/or the use of such nutritional food source and/or attractant for attracting and feeding deer and wildlife, such as on a particular plot of land.

Deer hunters and other land managers that want to attract and hold deer on their property commonly use supplemental feed and food plots (plantings of herbaceous plants and mast-producing trees) that provide additional food sources and nutrients beyond what is available from native vegetation (Koerth, B. H. and Kroll, J. C., Food Plots and Supplemental Feeding, SF Austin State University Press). These plantings and feeding programs can provide a large percentage of the diet of deer and wildlife in the area depending on available natural food supply, as well as increase the carrying capacity of the land to provide food for increased numbers of game individuals. These programs can be important in years with poor natural food production due to drought, harsh winters, and other weather events.

The American chestnut (Castanea dentata) was once the most common tree in eastern North America, comprising 25-50% of the forest canopy, until the American chestnut was almost completely destroyed by the chestnut blight—a bark fungus introduced from the Orient (Miller, G., “Chestnuts”, in A Guide to Nut Tree Culture in North America, Vol. 1, Northern Nut Growers Association, Fulbright, D. W. ed., 2003, pp. 167-182). The American chestnut was the primary mast (food) source for game and wildlife in eastern North America before the introduction of the chestnut blight. The American chestnut's prolific production of nut mast provided the major nutritional food source for deer and other wildlife during fall and winter, being comprised of up to 10% protein with a high quality amino acid balance similar to an egg, 40% carbohydrate and 2-3% fat (Burnett, M., “The Grain that Grows on a Tree: Chestnut Works”, Journal of the Chestnut Growers of America, 1985).

### BRIEF SUMMARY

Embodiments pertain to a method of attracting and/or feeding one or more animals, including, but not limited to: game, wildlife, deer, whitetail deer (Odocoileus virginianus), moose, elk, antelope, goats, cows, horses, turkey, birds, raccoons, chipmunks, donkeys, elephants, possum, squirrels, rabbits, mice, and buffalo. Embodiments of the invention relate to a nutritional food source (feed) and/or attractant that incorporates one or more of the following: whole chestnuts; chestnut kernels and/or kernel pieces; and ground chestnut flour. Specific embodiments incorporate chestnut flour and one or more of the following: whole chestnuts; chestnut kernels; and kernel pieces. Specific embodiments incorporate one or more of the following: whole chestnuts; chestnut kernels; kernel pieces, and incorporate less than 2%, less than 1%, less than 0.9%, less than 0.8%, less than 0.7%, less than 0.6%, and/or less than 0.5% chestnut flour. The attractant and/or feed can be used to feed and/or attract game, wildlife, deer, whitetail deer (Odocoileus virginianus), and/or other animals.

In specific embodiments, the whole chestnuts; chestnut kernels and/or kernel pieces; and ground chestnut flour can be dried such that the whole chestnuts; chestnut kernels and/or kernel pieces; and ground chestnut flour have a moisture level of less than or equal to one of the following: 15%, less than or equal to 10%, less than or equal to 8%, and/or 14%, 13%, 12%, 11%, 10%, 9%, 8%, 7%, 6%, 5%, and 4%, and/or in a range between any two of these listed percentages, such as in the range of 4-8% moisture. Embodiments of the subject feed and/or attractant can incorporate at least 5%, at least 10%, at least 15%, at least 20%, at least 25%, at least 30%, at least 35%, at least 40%, at least 45%, at least 50%, and/or in a range between any two of these listed percentages, by weight, or by volume, of dried whole chestnuts; dried chestnut kernels and/or kernel pieces; and dried, ground chestnut flour. Embodiments of the subject feed and/or attractant can incorporate at least one of the following: 5%, 6%, 7%, 8%, 9%, 10%, 11%, 12%, 13%, 14%, 15%, 16%, 17%, 18%, 19%, 20%, 21%, 22%, 23%, 24%, and 25%, and/or in a range between any two of these listed percentages, by weight, or by volume, of one or more of the following: whole chestnuts, dried chestnut kernels and/or kernel pieces; and dried, ground chestnut flour.

Specific embodiments can also incorporate stabilized rice bran and/or calcium carbonate. A specific embodiment pertains to a feed and/or attractant that incorporates dried whole chestnuts, dried chestnut kernels and/or kernel pieces, and dried, ground chestnut flour as a primary ingredient, in combination with stabilized rice bran and calcium carbonate. The combination of one or more of the following: dried whole chestnuts, dried chestnut kernels and/or kernel pieces, and dried, ground chestnut flour, in combination with stabilized rice bran and/or calcium carbonate, produces an attractant and/or feed to feed and/or attract deer. Specific embodiments pertain to a feed and/or attractant that incorporates dried whole chestnuts, dried chestnut kernels and/or kernel pieces, and dried, ground chestnut flour as a primary ingredient, in combination with stabilized rice bran, and with less than 2%, 1%, 0.9%, 0.8%, 0.7%, 0.6%, 0.5%, 0.4%, 0.3%, 0.2%, and/or 0.1%, by weight, or by volume, calcium carbonate. Specific embodiments pertain to a feed and/or attractant that incorporates dried whole chestnuts, dried chestnut kernels and/or kernel pieces, and dried, ground chestnut flour as a primary ingredient, in combination with calcium carbonate, and incorporate less than 2%, 1%, 0.9%, 0.8%, 0.7%, 0.6%, 0.5%, 0.4%, 0.3%, 0.2%, and/or 0.1%, by weight, or by volume, stabilized rice bran.

Chestnuts that can be utilized in accordance with various embodiments of the invention include one or more of the following: the American chestnut (Castanea dentata), the Japanese chestnut (Castanea crenata), the Chinese chestnut (Castanea mollissima), European (sweet) chestnut (Castanea sativa), and hybrids thereof. A specific hybrid that can be utilized is Dunstan, which is a hybrid of the Chinese chestnut and the American chestnut. A specific embodiment incorporates the American chestnut. Further specific embodiments incorporate one or more of the following: Japanese chestnuts, Chinese chestnuts, European chestnuts, and hybrids thereof, and do not include American chestnuts. Specific embodiments can incorporate other ingredients as well.

### DETAILED DISCLOSURE

In some embodiments, the chestnut kernels and kernel pieces can include a portion of the pellicle of the chestnut. In specific embodiments, the chestnut kernels and/or kernel pieces can be at least 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, and/or 100%, by weight, or by volume, of the chestnut from which the kernel and/or kernel piece originated, and/or of an average chestnut, by weight or by volume, respectively, used to produce the attractant and/or feed, prior to or after drying. In specific embodiments, chestnut flour can incorporate chestnut flour particles that are less than 2%, 1.5%, 1.0%, 0.9%, 0.8%, 0.7%, 0.6%, and/or 0.5%, by weight, or volume, of the chestnut from which the kernel and/or kernel piece originated, or of an average chestnut, by weight, or by volume, used to produce the attractant and/or feed, prior to or after drying.

Aspects of the present invention can be utilized for feeding and/or attracting deer; however, it is also contemplated that the present invention can be utilized for feeding and/or attracting a variety of other wild and domestic animals that consume nuts, such as but not limited to moose, elk, antelope, goats, cows, horses, turkey, birds, raccoons, chipmunks, donkeys, elephants, possum, squirrels, rabbits, mice, and buffalo.

In one aspect of the present invention, an attractant and/or feed for deer is provided. Embodiments of the subject attractant and/or feed can incorporate between 5% and 50%, by weight, or volume, of one or more of the following: whole chestnuts; chestnut kernels and/or kernel pieces; and chestnut flour (such as dried chestnut flour), where the whole chestnuts and/or chestnut kernels and/or kernel pieces make up between 5% and 50%, between 10% and 40%, between 15% and 30%, between 20% and 25%, at least 5%, at least 10%, at least 15%, at least 20%, at least 25%, at least 30%, at least 35%, at least 40%, at least 45%, and/or at least 50%, by weight, or by volume, of the subject feed and/or attractant, and the chestnut flour (such as dried chestnut flour) makes up between 5% and 50%, between 10% and 40%, between 15% and 30%, between 20% and 25%, at least 5%, at least 10%, at least 15%, at least 20%, at least 25%, at least 30%, at least 35%, at least 40%, at least 45%, and/or at least 50%, by weight, or by volume, of the subject feed and/or attractant. In some embodiments, dried whole chestnuts and/or dried chestnut kernels and/or kernel pieces, and dried ground chestnut flour can make up between 8% and 12%, between 9% and 11%, between 9.5% and 10.5%, and/or between 5% and 15%, by weight, or by volume, of the subject feed and/or attractant. In additional embodiments, dried whole chestnut and/or dried chestnut kernels and/or kernel pieces, and dried ground chestnut flour can make up between 12% and 18%, between 13% and 17%, between 14% and 16%, between 14.5% and 15.5%, between 19% and 21%, between 18% and 22%, between 17% and 23%, between 16% and 24%, between 15% and 25%, and/or between 10% and 20%, by weight, or by volume, of the subject feed and/or attractant.

Chestnuts utilized with respect to specific embodiments of the subject feed and/or attractant can be harvested in, for example, September and October (and sometimes August and November), from orchards in various locations. Because fresh chestnuts have a live embryo capable of growing a tree, chestnuts contain approximately 40% carbohydrates and approximately 45% water. If the embryo dries out during harvest, the carbohydrate can become a substrate for mold to attack the kernel of the nut, especially in growing regions with high humidity during these months.

The mass of individual fresh chestnuts used to produce embodiments of the subject attractant and/or feed can vary from 40-220 nuts/kg, with the larger nuts typically commanding a higher price on the market. Embodiments can use smaller nuts, with masses of 100 nuts/kg or less before drying, and optionally dry the nuts. In some species, such as the European, or Sweet Chestnuts, (C. sativa), the lower-quality chestnut varieties may have crenulations into which the pellicle grows, making the pellicle more difficult to fully remove. Such chestnuts are therefore more frequently dried because the taste is not as sweet as the taste of nuts that have a whole, entire kernel with limited crenulations, as the pellicle's presence bitters the chestnut taste due to the pellicle's high tannin content. Similarly, the quality of chestnut flour is determined by the flour's sweetness, which can be a function of the degree to which the pellicles were removed prior to grinding.

For chestnuts to be able to be used in a condition that is stable and has a low spoilage rate at room temperatures of, for example, 0-30, 10-30, 20-30, and/or 20-25 degrees Celsius, when sealed from moisture, the whole chestnuts, chestnut kernels and/or kernel pieces, and/or chestnut flour incorporated in embodiments of the invention can be dried. In an embodiment, the nuts/flour are dried to a level of less than 15%, 14%, 13%, 12%, 11%, 10%, 9%, 8%, 7%, 6%, 5%, 4%, and/or 3% moisture content. In an embodiment, the nuts/flour are dried to a level of 3% to 9%, 4% to 8%, 5% to 7%, 5% to 10%, and/or 3% to 7% moisture content.

In an embodiment, an initial step after harvest is to place the chestnuts in a water tank, in which the good nuts sink and the rotten nuts float and are removed. The remaining unspoiled nuts, or good nuts, can then be optionally sorted. If desired, the good nuts can then be stored in a refrigerated environment. In an embodiment, the good nuts are stored in an environment having a temperature in the range of 0-5, 1-5, 1-4, 1-3, 1-2, 2-3, 3-4, 2-4, and/or 4-5 degrees Celsius, where the nuts stay viable and in fresh condition. It is preferred not to freeze the chestnuts, which can kill the embryo, but, rather, keep the temperature low enough to reduce biological activity such that mold will not grow, or grow well.

In one aspect, the present invention provides a method of removing moisture from chestnuts; chestnut kernels and/or kernel pieces; and/or chestnut flour. Embodiments of the subject method for removing moisture from the chestnuts; and/or chestnut kernels and/or kernel pieces; and/or chestnut flour involves exposing the chestnuts; chestnut kernels and/or kernel pieces; and/or chestnut flour to warm air for at least 4, 5, 6, 7, and/or 8 days, and/or for 4-16, 5-15, 6-14, 7-13, and/or 8 to 12 days. In specific embodiments, exposing the chestnuts; chestnut kernels and/or kernel pieces/and/or chestnut flour to the warm air causes the moisture percentage to drop to less than 15%, 14%, 13%, 12%, 11%, 10%, 9%, 8%, 7%, 6%, and/or 5% moisture, or in a range between any two of the cited percentages. Specific embodiments involve grinding the chestnut kernels and/or chestnut kernel pieces, to varying size chestnut kernel pieces and/or chestnut flour, where a surface area of the resulting varying size chestnut kernels and/or chestnut flour is greater than a surface area of the initial chestnut kernels and/or chestnut kernel pieces. In some aspects, the subject method involves incorporating varying size chestnut portions and/or chestnut flour to be utilized for preparing an attractant and/or feed for animals, such as, but not limited to deer, and/or positioning the attractant and/or feed in a location accessible to deer or other animals.

In some embodiments, the method causes the moisture percentage, by weight, of the chestnut kernels and/or kernel pieces, and/or chestnut flour to drop to less than or equal to 10%, 9%, 8%, 7%, 6%, 5%, 4%, 3%, and/or 2%, or to in a range between any two of the identified percentages. In further embodiments, the method causes the moisture percentage of the chestnut portions to drop to less than or equal to 8%, and in other embodiments, the method causes the moisture percentage of the chestnut portions to drop to less than or equal to 8%

The drying process can be accomplished by, for example, exposing the fresh chestnuts to a hot air stream. In an embodiment, moving air (such as blown by a fan) in the range 30-40, 30-35, and/or 32-35 degrees Celsius can be used. In a further specific embodiment, moving air in the range 32-35 degrees Celsius can be used for a period of at least 8 days, at least 12 days, and/or 8-12 days. In specific embodiments, the chestnuts are dried to a degree such that a chestnut powder is produced by grinding. In other embodiments, the moisture content is such that the grinding results in a paste instead of a flour, and the paste can be, optionally, dried at a later time. Drying the chestnuts also increases their sugar levels. The chestnuts can be stored in an environment that has been modified to reduce oxygen concentration, such as by replacing some of the volume of the environment with nitrogen. By reducing the oxygen concentration, by using, for example, a nitrogen flush, during the bagging of the chestnuts, moisture content can be decreased.

Once the chestnuts have attained the desired moisture level, the shells can be removed from the nut kernels. In specific embodiments, the shells and at least a portion of the pellicles can be removed from the nut kernels. The drying process typically shrinks the kernel as the water is evaporated out of the chestnuts, and loosens the attachment of the pellicle to the kernel, while the shell size remains approximately the same size, or the same size. In an embodiment, the dried chestnuts are run through a mill, such as a hammer mill, that cracks the dried shells, and the dried shells can then be separated from the kernels. The shells can be separated from the kernels by, for example, using an air blast. The pellicles can also be removed from the kernels. In embodiments involving removing the pellicles, air blast or other techniques can be used. An air blast can also be used to remove the pellicles from the kernels. In a specific embodiment, an air blast is used to separate the shells and the pellicles from the kernels, where the kernels are heavier and the lighter weight dried shells and pellicles are removed by passing them over a screen with an air stream blowing up from underneath.

The dried kernels can then be, optionally, visually or optically sorted for quality control. After sorting, if desired, the kernels can be run over a screen to separate partial kernels and pieces. Such screens can have various size openings that allow certain size kernel pieces to fall through.

Embodiments of the subject feed and/or attractant can incorporate a dried, ground chestnut flour. In an embodiment, a ground chestnut flour can be produced by running the partial kernels and pieces through a mill, such as a roller mill, such that the partial kernels and pieces are ground into a desired consistency. Deer have 100,000 taste buds (compared to humans who have only 10,000), and deer's sense of smell and taste is extremely important in locating food sources. Chestnuts have a mild sweet aroma, which can be enhanced by the grinding process on creation of increased surface area of the particles of dried chestnut. Specific embodiments use a commercial grinder, as are known in the art, such as a roller mill. The chestnut can be ground to varying dimensions. In a specific embodiment, such kernels and kernel pieces can have dimensions in the range of 1 mm to 2 cm, in the range 0.5 mm to 2.5 cm, in the range 5 mm to 1 cm, in the range 1 mm to 2.5 cm, and/or in the range 1 mm to 1 cm, in diameter. In a specific embodiment, the chestnut flour can be ground to the consistency of whole wheat flour, with the dimensions of the flour particles in the range of superfine to coarse. In specific embodiments, the flour particles can have diameters up to 0.01 mm, up to 0.1 mm, up to 0.2 mm, up to 0.3 mm, up to 0.4 mm, up to 0.5 mm, up to 0.6 mm, up to 0.7 mm, up to 0.8 mm, up to 0.9 mm, up to 1 mm, up to 1.5 mm, up to 2 mm, and/or in a range between any two of the cited diameters. In further specific embodiments, the attractant and/or feed incorporates chestnut flour that makes up at at least 95%, at least 96%, at least 97%, at least 98%, at least 99%, at least 99.5%, 100%, and/or in a range between any two of the cites percentages of the attractant and/or feed, where the chestnut flour can have diameters up to 0.01 mm, up to 0.1 mm, up to 0.2 mm, up to 0.3 mm, up to 0.4 mm, up to 0.5 mm, up to 0.6 mm, up to 0.7 mm, up to 0.8 mm, up to 0.9 mm, up to 1 mm, up to 1.5 mm, up to 2 mm, and/or in a range between any two of the cited diameters.

The dried whole chestnut kernels, dried chestnut kernels and/or kernel pieces, and/or dried ground chestnut flour can make up at least 5%, at least 10%, at least 15%, at least 20%, at least 25%, at least 30%, at least 35%, at least 40%, at least 45%, and/or at least 2550% by weight, or by volume, of embodiments of the subject feed and/or attractant, and/or in a range between any two of the identified percentages. Various other ingredients, such as brans or meals, soy bean meal, dried corn meal, and/or corn, can be combined with the dried whole chestnut kernels, dried chestnut kernels and/or kernel pieces, and/or dried ground chestnut flour to produce the feed and/or attractant. Additives can also be added, as well as grain by-products. In a specific embodiment, dried whole chestnut kernels, dried chestnut kernels and/or kernel pieces, and/or dried ground chestnut flour can be combined with rice bran in a 20-25% chestnut: 75-80% rice bran mix. Other embodiments can have a 0-5% chestnut: 95-100% rice bran; 5-10% chestnut: 90-95% rice bran; 10-15% chestnut: 85-90% rice bran; 15-20% chestnut: 80-85% rice bran; 25-30% chestnut: 70-75% rice bran; 30-35% chestnut: 65-70% rice bran; 35-40% chestnut: 60-65% rice bran; 40-45% chestnut: 55-60% rice bran; 45-50% chestnut: 50-55% rice bran; 50-55% chestnut: 45-50% rice bran; 55-60% chestnut: 40-45% rice bran; 60-65% chestnut: 35-40% rice bran; 65-70% chestnut: 30-35% rice bran; 70-75% chestnut: 25-30% rice bran; 50-75% chestnut: 25-50% rice bran; 75-80% chestnut: 20-25% rice bran; 80-85% chestnut: 15-20% rice bran; 85-90% chestnut: 10-15% rice bran; 90-95% chestnut: 5-10% rice bran; 95-100% chestnut: 0-5% rice bran; and/or 75-100% chestnut: 0-25% rice bran mix. Specific embodiments can incorporate commercially available rice bran.

In some embodiments, stabilized rice bran is utilized. In a specific embodiment, stabilized rice bran is created by heating rice bran and calcium carbonate, in an extruder so that the resulting rice bran does not spoil during storage at room temperature for a desired period of time such as at least one month, at least 3 months, at least 6 months, at least 9 months, and/or at least 12 months. In some embodiments, the stabilized rice bran does not spoil during storage between one month and 12 months. In other embodiments, calcium carbonate is not added with the rice bran.

In some embodiments, calcium carbonate can be added to the rice bran before, after, or during, the stabilization process to form a rice bran/calcium carbonate mixture in order to provide calcium content to the rice bran since rice bran is richer in phosphorus than calcium. Embodiments can have a 0-5% chestnut: 95-100% rice bran/calcium carbonate mixture; 5-10% chestnut: 90-95% rice bran/calcium carbonate mixture; 10-15% chestnut: 85-90% rice bran/calcium carbonate mixture; 15-20% chestnut: 80-85% rice bran/calcium carbonate mixture; 20-25% chestnut: 75-80% rice bran/calcium carbonate mixture; 25-30% chestnut: 70-75% rice bran/calcium carbonate mixture; 30-35% chestnut: 65-70% rice bran/calcium carbonate mixture; 35-40% chestnut: 60-65% rice bran/calcium carbonate mixture; 40-45% chestnut: 55-60% rice bran/calcium carbonate mixture; 45-50% chestnut: 50-55% rice bran/calcium carbonate mixture; 50-55% chestnut: 45-50% rice bran/calcium carbonate mixture; 55-60% chestnut: 40-45% rice bran/calcium carbonate mixture; 60-65% chestnut: 35-40% rice bran/calcium carbonate mixture; 65-70% chestnut: 30-35% rice bran/calcium carbonate mixture; 70-75% chestnut: 25-30% rice bran/calcium carbonate mixture; 50-75% chestnut: 25-50% rice bran/calcium carbonate mixture; 75-80% chestnut; 20-25% rice bran/calcium carbonate mixture; 80-85% chestnut: 15-20% rice bran/calcium carbonate mixture; 85-90% chestnut: 10-15% rice bran/calcium carbonate mixture; 90-95% chestnut: 5-10% rice bran/calcium carbonate mixture; 95-100% chestnut: 0-5% rice bran/calcium carbonate mixture; and/or 75-100% chestnut: 0-25% rice bran/calcium carbonate mixture.

Stabilized rice bran is an ingredient that is used in many deer and wildlife attractant mixes and can have a nutritive content of approximately 12.5% by weight of protein, approximately 20% by weight of crude fat, and approximately 13% by weight of fiber, and which can readily be consumed by deer and wildlife. Stabilized rice bran can be produced in accordance with methods known in the art and/or taught in U.S. Pat. No. 6,616,924, which is incorporated herein in its entirety.

Additional additives, such as animal feed acceptable carriers and vehicles, that may be used in the animal feed compositions of this invention include, but are not limited to, ion exchangers, alumina, aluminum stearate, lecithin, serum proteins, such as serum albumin, buffer substances such as phosphates, glycine, sorbic acid, potassium sorbate, partial glyceride mixtures of saturated vegetable fatty acids, water, salts or electrolytes, such as protamine sulfate, disodium hydrogen phosphate, potassium hydrogen phosphate, sodium chloride, zinc salts, colloidal silica, magnesium trisilicate, polyvinyl pyrrolidone, cellulose-based substances, polyethylene glycol, sodium carboxymethylcellulose, polyacrylates, waxes, polyethylene-polyoxypropylene-block polymers, polyethylene glycol, propylene glycol and wool fat. Other food materials or food grade materials useful in the compositions herein include molasses, honey, and other coating materials.

The chestnuts that comprise the attractant/feed can be of one or multiple species, such as one or more of the following: Chinese Chestnut (Castanea mollissima), European Chestnut (C. sativa), American Chestnut (C. dentata), Japanese Chestnut (C. crenata) or hybrids between any of these species.

Chestnuts have a comparable nutritional makeup to grains, and, in particular, have a similar nutritional makeup to brown rice. Chestnuts have up to 10% by weight (e.g., 5-10%) of protein of a very high quality, with an amino acid balance of an egg, having similar levels of essential amino acids tryptophan, lysine, methionine and cystine and isoleucine (Burnett, 1985). In some embodiments of the present invention, the chestnut portions and/or chestnut flour have a nutritive value of 3% to 10% protein, 35% to 45% carbohydrate, and 2% to 3% fat. Embodiments of the subject feed and/or attractant can be produced into a powdered form that can be packaged and stored for extended periods of time without degradation or loss of effective action. In an embodiment having a 20-25% chestnut: 75-80% rice bran combination, the chestnuts and stabilized rice bran are combined in a powdered form that can be packaged and stored for periods of at least a year, or longer, without degradation or loss of effective action.

Additional aspects of the present invention provide an animal (e.g., deer) feed kit comprising a container with at least one component contained therein. One of the components includes 5% to 50%, by volume, or by weight, whole chestnuts; chestnut kernels or kernel pieces; or ground chestnut flour, or a combination thereof. An optional component is 50% to 95%, by volume, or by weight, of stabilized rice bran. Another optional component is calcium carbonate. Each of the one or more components is contained in the container and can be dispensed utilizing a dispenser on the container. In some embodiments, the dispenser dispenses a pre-measured quantity of the components contained in the container. In specific embodiments, the container can be a bag, sack, bucket, or other rigid, semi-rigid, or flexible type containers. In some embodiments, the deer feed kit includes instructions for using and/or dispensing the components. In yet another embodiment, the kit includes a dispensing cup, scoop, trowel, or the like for insertion into the container for allowing dispensing of the components.

In a specific embodiment, the subject attractant and/or feed is bagged in, for example, air tight polyethylene bags. Bags made of other materials can also be used. This bagging can be accomplished on a packaging line that weights the amount of the material being poured into each bag. In specific embodiments, these bags can hold from 5 to 50 lbs of the attractant and/or feed product. Specific embodiments can be packaged in sizes of 1 oz, 2 oz, 4 oz, 8 oz, 16 oz, 2 lbs, 3 lbs, 4 lbs, 5 lbs, and/or a size between any two of the cited sizes. Preferably, before sealing the bag, the air is purged from the bag. The air can be purged by, for example, flushing the bag with Nitrogen gas, which eliminates, or reduces, the oxygen from the bagged attractant and/or feed. Eliminating, or reducing, the oxygen from the sealed bag helps make the product stable and reduces decay or molding. In specific embodiments. decay or molding at room temperatures can be prevented (and/or greatly reduced) for periods of up to 6 months, up to 1 year, up to 18 months, up to 2 years, and/or longer, without the need to use artificial preservatives or chemicals (which can be potentially injurious to the animals).

In specific embodiments, the polyethylene bags are printed with artwork, product information, nutritional makeup, and UPC codes.

Once packaged in bags, the smaller bags can be packed in cardboard cases and the cases palletized for shipping. Larger bags can be palletized without the need to first be packed in cases. The quantity of units per pallet depends upon the size of the bag.

A specific embodiment, incorporating chestnut kernels pieces, chestnut flour, rice bran, and calcium carbonate, has 6.19% moisture, 13.23% fat, 10.68% protein, 5.88% ash, and 64.02% carbohydrate, with 7.0% crude fiber. Further specific embodiments can incorporate chestnut kernels pieces, chestnut flour, rice bran, and calcium carbonate, having 5-10% moisture, 10-16% fat, 8-14% protein, 4-8% ash, and 60-70% carbohydrate, with 5-9% crude fiber.

Specific embodiments of the subject attractant and/or feed can incorporate one or more of the following: whole chestnuts; chestnut kernels and/or kernel pieces; ground chestnut flour; stabilized rice bran; and/or calcium carbonate, that makes up at least 95%, at least 96%, at least 97%, at least 98%, at least 99%, at least 99.5%, 100%, and/or in a range between any two of the cites percentages of the attractant and/or feed.

### EMBODIMENTS

### Embodiment 1

An attractant and/or feed, comprising in the range of 5% to 50% by volume, or by weight of one or more of the following: whole chestnuts, chestnut kernels and/or chestnut kernel pieces, and chestnut flour.

This attractant and/or feed can be used to attract and/or feed an animal, such as a deer.

### Embodiment 2

The attractant and/or feed according to Embodiment 1, wherein the attractant and/or feed comprises in the range 10% to 40% by weight whole chestnuts, chestnut kernels and/or chestnut kernel pieces, and/or chestnut flour.

### Embodiment 3

The attractant and/or feed according to Embodiment 2, wherein the attractant and/or feed comprises in the range 20% to-25% by weight whole chestnuts, chestnut kernels and/or chestnut kernel pieces, and/or chestnut flour.

### Embodiment 4

The attractant and/or feed according to Embodiment 1, wherein the whole chestnuts, chestnut kernels and/or chestnut kernel pieces, and/or chestnut flour has a moisture content less than or equal to 15% moisture by weight.

### Embodiment 5

The attractant and/or feed according to Embodiment 1, wherein the whole chestnuts, chestnut kernels and/or chestnut kernel pieces, and/or chestnut flour has a moisture content in the range 4-8% moisture by weight.

### Embodiment 6

The attractant and/or feed according to Embodiment 1, wherein the whole chestnuts, chestnut kernels and/or chestnut kernel pieces, and/or chestnut flour has a moisture content of less than or equal to 10% moisture by weight.

### Embodiment 7

The attractant and/or feed according to Embodiment 1, wherein the whole chestnuts, chestnut kernels and/or chestnut kernel pieces, and/or chestnut flour has a moisture content of less than or equal to 8% moisture.

### Embodiment 8

The attractant and/or feed according to Embodiment 1, further comprising rice bran.

### Embodiment 9

The attractant and/or feed according to Embodiment 8, wherein the rice bran is stabilized rice bran, wherein the attractant and/or feed comprises in the range 75-80% by weight of stabilized rice bran.

### Embodiment 10

The attractant and/or feed according to Embodiment 8, further comprising calcium carbonate.

### Embodiment 11

The attractant and/or feed according to Embodiment 10, wherein the rice bran is stabilized rice bran, wherein the attractant and/or feed comprises in the range 75-80%, by weight, of stabilized rice bran and calcium carbonate.

### Embodiment 12

The attractant and/or feed according to Embodiment 1, wherein the attractant and/or feed comprises at least 10% by weight whole chestnuts, chestnut kernels and/or chestnut kernel pieces, and/or chestnut flour.

### Embodiment 13

The attractant and/or feed according to Embodiment 1, wherein the attractant and/or feed comprises at least 15% by weight whole chestnuts, chestnut kernels and/or chestnut kernel pieces, and/or chestnut flour.

### Embodiment 14

A method of removing moisture from chestnuts, comprising:

exposing chestnuts to warm air, wherein exposing the chestnuts to the warm air causes the moisture percentage to drop to less than or equal to 15% moisture;

shelling the chestnuts to produce chestnut kernels and/or chestnut kernel pieces; and

grinding the chestnut kernels and/or chestnut kernel pieces to produce varying size chestnut kernel pieces and/or chestnut flour, wherein a surface area of the varying size chestnut kernels and/or chestnut flour is greater than a surface area of the chestnut kernels and/or chestnut kernel pieces.

### Embodiment 15

The method according to Embodiment 14, wherein the varying size chestnut kernel pieces and/or chestnut flour have a nutritive value of 3% to 10% protein, 35% to 45% carbohydrate, and 2% to3% fat.

### Embodiment 16

The method according to Embodiment 14, wherein exposing the chestnuts to the warm air comprises exposing the chestnuts to the warm air for at least 8 days.

### Embodiment 17

The method according to Embodiment 14, wherein exposing the chestnuts to the warm air causes the moisture percentage to drop to less than or equal to 10%.

### Embodiment 18

The method according to Embodiment 14, wherein exposing the chestnuts to the warm air causes the moisture percentage to drop to between 4% and 8%.

### Embodiment 19

The method according to Embodiment 14, further comprising adding at least one additive to the chestnut kernels and/or chestnut kernel pieces, wherein the at least one additive is selected from the group consisting of: chestnut flour, soy bean meal, corn, dried corn meal, and combinations thereof.

### Embodiment 20

A method of preparing an attractant and/or feed, comprising:

exposing chestnuts to warm air, wherein exposing the chestnuts to the warm air causes the moisture percentage to drop to less than or equal to 15% moisture;

shelling the chestnuts to produce chestnut kernels and/or chestnut kernel pieces;

grinding the chestnut kernels and/or chestnut kernel pieces to produce a combination of varying size chestnut kernel pieces and/or chestnut flour, wherein a surface area of the varying size chestnut kernel pieces and/or chestnut flour is greater than a surface area of the chestnut kernels and/or chestnut kernel pieces; and

preparing an attractant and/or feed incorporating the varying size chestnut kernel pieces and/or chestnut flour.

This attractant and/or feed can be used to attract and/or feed an animal, such as a deer.

### Embodiment 21

The method according to Embodiment 20, wherein the varying size chestnut kernel pieces and/or chestnut flour have a nutritive value of 3% to 10% protein, 35% to 45% carbohydrate, and 2 to 3% fat.

### Embodiment 22

A method of attracting and/or feeding an animal, comprising:

providing an attractant and/or feed, wherein the attractant and/or feed comprises in the range 5% to 50% by weight whole chestnuts, chestnut kernels and/or chestnut pieces, and/or chestnut flour; and

positioning the attractant and/or feed in a location accessible to an animal.

### Embodiment 23

The method according to Embodiment 22, wherein positioning the attractant and/or feed in a location accessible to an animal attracts the animal.

### Embodiment 24

The method according to Embodiment 22, wherein positioning the attractant and/or feed in a location accessible to an animal feeds the animal.

### Embodiment 25

The method according to Embodiment 22, wherein the animal is selected from the group consisting of: game, wildlife, deer, whitetail deer (Odocoileus virginianus), moose, elk, antelope, goats, cows, horses, turkey, birds, raccoons, chipmunks, donkeys, elephants, possum, squirrels, rabbits, mice, and buffalo.

### Embodiment 26

The method according to Embodiment 22, wherein the animal is selected from the group consisting of: game, wildlife, deer, whitetail deer (Odocoileus virginianus), moose, and elk.

### Embodiment 27

The method according to Embodiment 22, wherein the animal is a deer.

### Embodiment 28

The method according to Embodiment 22, wherein the animal is a whitetail deer (Odocoileus virginianus).

### Embodiment 29

The method according to Embodiment 22, wherein providing the attractant and/or feed comprises preparing the attractant and/or feed, wherein preparing the attractant and/or feed comprises:

exposing chestnuts to warm air, wherein exposing the chestnuts to the warm air causes the moisture percentage to drop to less than or equal to 15% moisture;

shelling the chestnuts to produce chestnut kernels and/or chestnut kernel pieces;

grinding the chestnut kernels and/or chestnut kernel pieces to produce a combination of varying size chestnut kernel pieces and/or chestnut flour, wherein a surface area of the varying size chestnut kernel pieces and/or chestnut flour is greater than a surface area of the chestnut kernels and/or chestnut kernel pieces; and

preparing an attractant and/or feed incorporating the varying size chestnut kernel pieces and/or chestnut flour.

### Embodiment 30

The method according to Embodiment 29, wherein preparing the attractant and/or feed comprises producing a combination of varying size chestnut kernel pieces and chestnut flour; and preparing the attractant and/or feed such that the attractant and/or feed comprises the combination of varying size chestnut kernel pieces and chestnut flour.

### Embodiment 31

The method according to Embodiment 30, wherein producing the combination of varying size chestnut pieces and chestnut flour comprises:

drying chestnuts such that a moisture percentage of the chestnuts is less than or equal to 15% moisture;

shelling the chestnuts to produce chestnut kernels and/or chestnut kernel pieces;

grinding the chestnut kernels and/or chestnut kernel pieces to the combination of varying size chestnut kernel pieces and chestnut flour, wherein a surface area of the combination of varying size chestnut kernel pieces and chestnut flour is greater than a surface area of the chestnut kernels and/or chestnut kernel pieces.

### Embodiment 32

The method according to Embodiment 31, wherein drying the chestnuts comprises exposing the chestnuts to warm air for at least 8 days.

### Embodiment 33

A deer attractant and/or feed kit, comprising:

a container with at least one component contained therein, the at least one component comprising in the range of 5% to 50% by volume, or by weight of one or more of the following: whole chestnuts, chestnut kernels and/or chestnut kernel pieces, and chestnut flour.

### Embodiment 34

The kit according to Embodiment 33, wherein the container is a bag.

### Embodiment 35

The kit according to Embodiment 33, wherein the container comprises a dispenser for dispensing at least one component.

### Embodiment 36

The kit according to Embodiment 33, further comprising instructions for use thereof.

### Embodiment 37

The kit according to Embodiment 33, wherein the at least one component further comprises 50% to 95%, by volume, or by weight, stabilized rice bran.

### Embodiment 38

The kit according to Embodiment 37, wherein the at least one component further comprises calcium carbonate.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method of attracting and/or feeding an animal, comprising:
providing an attractant and/or feed, wherein the attractant and/or feed comprises in the range of 5% to 50%, by volume, or by weight, of one or more of the following: whole chestnuts, chestnut kernels, chestnut pieces, and chestnut flour; and
positioning the attractant and/or feed in a location accessible to an animal.

2. The method according to claim 1, wherein positioning the attractant and/or feed in a location accessible to an animal attracts the animal.

3. The method according to claim 1, wherein positioning the attractant and/or feed in a location accessible to an animal feeds the animal.

4. The method according to claim 1, wherein the animal is selected from the group consisting of: game, wildlife, deer, whitetail deer (Odocoileus virginianus), moose, elk, antelope, goats, cows, horses, turkey, birds, raccoons, chipmunks, donkeys, elephants, possum, squirrels, rabbits, mice, and buffalo.

5. The method according to claim 1, wherein the animal is selected from the group consisting of: game, wildlife, deer, whitetail deer (Odocoileus virginianus), moose, and elk.

6. The method according to claim 1, wherein the animal is a deer.

7. The method according to claim 1, wherein the animal is a whitetail deer (Odocoileus virginianus).

8. The method according to claim 1,
wherein providing the attractant and/or feed comprises preparing the attractant and/or feed,
wherein preparing the attractant and/or feed comprises:
producing a combination of varying size chestnut kernel pieces and chestnut flour; and
preparing the attractant and/or feed such that the attractant and/or feed comprises the combination of varying size chestnut kernel pieces and chestnut flour,
wherein producing the combination of varying size chestnut pieces and chestnut flour comprises:
drying chestnuts such that a moisture percentage of the chestnuts is less than or equal to 15% moisture, by weight;
shelling the chestnuts to produce chestnut kernels and/or chestnut kernel pieces; and
grinding the chestnut kernels and/or chestnut kernel pieces to produce the combination of varying size chestnut kernel pieces and chestnut flour,
wherein a surface area of the combination of varying size chestnut kernel pieces and chestnut flour is greater than a surface area of the chestnut kernels and/or chestnut kernel pieces.

9. The method according to claim 8, wherein drying the chestnuts comprises exposing the chestnuts to warm air for at least 8 days.

10. A method according to claim 8,
wherein drying the chestnuts such that a moisture percentage of the chestnuts is less than or equal to 15% moisture, by weight, comprises:
exposing the chestnuts to warm air, wherein exposing the chestnuts to the warm air causes the moisture percentage to drop to less than or equal to 15% moisture, by weight.

11. The method according to claim 10, wherein the combination of varying size chestnut kernel pieces and chestnut flour has a nutritive value in the range of 3% to 10% protein, in the range of 35% to 45% carbohydrate, and in the range of 2% to 3% fat.

12. The method according to claim 1, wherein the attractant and/or feed comprises in the range of 5% to 50%, by weight, of the one or more of the following: whole chestnuts, chestnut kernels, chestnut kernel pieces, and chestnut flour.

13. The method according to claim 1, wherein the attractant and/or feed comprises in the range of 5% to 50%, by volume, of the one or more of the following: whole chestnuts, chestnut kernels, chestnut kernel pieces, and chestnut flour.

14. The method according to claim 12, wherein the attractant and/or feed comprises in the range of 10% to 40%, by weight, of the one or more of the following: whole chestnuts, chestnut kernels, chestnut kernel pieces, and chestnut flour.

15. The method according to claim 12, wherein the attractant and/or feed comprises in the range of 20% to 25%, by weight, of the one or more of the following: whole chestnuts, chestnut kernels, chestnut kernel pieces, and chestnut flour.

16. The method according to claim 12, wherein the attractant and/or feed comprises at least 10%, by weight, of the one or more of the following: whole chestnuts, chestnut kernels, chestnut kernel pieces, and chestnut flour.

17. The method according to claim 12, wherein the attractant and/or feed comprises at least 15%, by weight, of the one or more of the following: whole chestnuts, chestnut kernels, chestnut kernel pieces, and chestnut flour.

18. The method according to claim 12, wherein the one or more of the following: whole chestnuts, chestnut kernels, chestnut kernel pieces, and chestnut flour has a moisture content of less than or equal to 15% moisture, by weight.

19. The method according to claim 12, wherein the one or more of the following: whole chestnuts, chestnut kernels, chestnut kernel pieces, and chestnut flour has a moisture content in the range of 4% to 8% moisture, by weight.

20. The method according to claim 12, wherein the one or more of the following: whole chestnuts, chestnut kernels, chestnut kernel pieces, and chestnut flour has a moisture content of less than or equal to 10% moisture, by weight.

21. The method according to claim 12, wherein the one or more of the following: whole chestnuts, chestnut kernels, chestnut kernel pieces, and chestnut flour has a moisture content of less than or equal to 8% moisture, by weight.

22. The method according to claim 12, wherein the attractant and/or feed further comprises rice bran.

23. The method according to claim 22, wherein the rice bran is stabilized rice bran, wherein the attractant and/or feed comprises in the range of 75% to 80%, by weight, of stabilized rice bran.

24. The method according to claim 22, wherein the attractant and/or feed further comprises calcium carbonate.

25. The method according to claim 20, wherein the rice bran is stabilized rice bran, wherein the attractant and/or feed comprises in the range of 75% to 80%, by weight, of one or more of the following: the stabilized rice bran and the calcium carbonate.

26. The method according to claim 12,
wherein the one or more of the following: whole chestnuts, chestnut kernels, chestnut kernel pieces, and chestnut flour comprises one or more of the following: the chestnut kernel pieces and the chestnut flour,
wherein the one or more of the following: the chestnut kernel pieces and the chestnut flour have a nutritive value in the range of 3% to 10% protein, in the range of 35% to 45% carbohydrate, and in the range of 2% to 3% fat.

27. The method according to claim 10, wherein the attractant and/or feed is an attractant.

28. The method according to claim 27, wherein the attractant is an animal attractant.

29. The method according to claim 27, wherein the attractant is a deer attractant.

30. The method according to claim 10, wherein the attractant and/or feed is a feed.

31. The method according to claim 30, wherein the attractant is an animal feed.

32. The method according to claim 30, wherein the attractant is a deer feed.

33. The method according to claim 12,
wherein the attractant and/or feed comprises in the range of 10% to 40%, by weight, of the one or more of the following: whole chestnuts, chestnut kernels, chestnut kernel pieces, and chestnut flour,
wherein the one or more of the following: whole chestnuts, chestnut kernels, chestnut kernel pieces, and chestnut flour has a moisture content in the range of 4% to 8% moisture, by weight.

34. The method according to claim 33,
wherein the attractant and/or feed further comprises rice bran.

35. The method according to claim 34, wherein the rice bran is stabilized rice bran, wherein the attractant and/or feed comprises in the range of 75% to 80%, by weight, of stabilized rice bran.

36. The method according to claim 34, wherein the attractant and/or feed further comprises calcium carbonate.

37. The method according to claim 36,
wherein the rice bran is stabilized rice bran, wherein the attractant and/or feed comprises in the range of 75% to 80%, by weight, of one or more of the following: the stabilized rice bran and the calcium carbonate.

38. The method according to claim 37,
wherein the one or more of the following: whole chestnuts, chestnut kernels, chestnut kernel pieces, and chestnut flour comprises one or more of the following: the chestnut kernel pieces and the chestnut flour,
wherein the one or more of the following: the chestnut kernel pieces and the chestnut flour have a nutritive value in the range of 3% to 10% protein, in the range of 35% to 45% carbohydrate, and in the range of 2% to 3% fat.

39. The method according to claim 38, wherein the attractant and/or feed is an attractant.

40. The method according to claim 39, wherein the attractant is an animal attractant.

41. The method according to claim 39, wherein the attractant is a deer attractant.

42. The method according to claim 38, wherein the attractant and/or feed is a feed.

43. The method according to claim 42, wherein the attractant is an animal feed.

44. The method according to claim 43, wherein the attractant is a deer feed.
